(19) United States
(12) Patent Application Publication
(10) Pub. No.: US 2005/0193740 A1
(43) Pub. Date: Sep. 8, 2005

(54) Stratojet - system and method for automatically maintaining optimum oxygen content in high altitude turbojet engines

(76) Inventor: Adolph Mondry, Plymouth, MI (US)

Correspondence Address: ADOLPH MONDRY, 753 VIRGINIA, PLYMOUTH, MI, 48170, US

(21) Appl. No.: 10/793,624

(22) Filed: Mar. 5, 2004

(51) Int. Cl. F02C 9/00

(52) U.S. Cl. 60/772; 60/794

(57) ABSTRACT

The Stratojet is a method and apparatus for maintaining a desired oxygen content level at the outlet of a turbojet engine to increase speed, altitude, and thrust, and to decrease flameouts and includes delivering a second liquid oxidant dosage to the duct upstream of the compressor while repeatedly sequencing through the plurality of sequential oxygen content doses at the outlet beginning with the first oxygen content dose and proceeding to an adjacent oxygen content dose in the sequence after a predetermined time interval has elapsed. The second oxidant dosage is delivered until the oxygen content level attains the desirable range, at which point corresponding oxidant and oxygen content doses are selected from the plurality of sequential oxidant doses and oxygen content doses. The method also includes delivering the selected oxidant dose and oxygen content dose so as to maintain the desired oxygen content range at the outlet.

### CROSS REFERENCES TO RELATED APPLICATIONS

Adolph Mondry—System and method for automatically maintaining a blood oxygen level. U.S. Pat. No. 5,682,877, Nov. 4, 1997—herein referred to as 877. The flow charts of that device are similar to those of the Stratojet.

Adolph Mondry—The Voltage Dosimeter—System and method for supplying variable voltage to an electric circuit. P. N. application number not yet available. The flow charts of that device are identical to that of the Stratojet.

Adolph Mondry—The Automatic Furnace—System and method for automatically maintaining a multiburner furnace. P. N. application number not yet available. The flow charts of that device are identical to that of the Stratojet.

Bevin C. McKinney—Tubojet with precompressor injected oxidizer—Patent Application Ser. No. 20030079463—herein referred to as '463. May 1, 2003. Demonstrates a high altitude turbojet engine.

### FEDERALLY SPONSORED RESEARCH GRANTS

There are no Federally sponsored research grants available to those involved in the research and development of this device.

### BACKGROUND OF THIS INVENTION

As '463 teaches, high altitude turbojets rely on liquid oxygen and related compounds to be administered upstream of the compressor to improve high altitude performance and thrust. This reduces air volume, improving compressor function, increasing mass flow, fuel consumption, exhaust gas temperatures, and reduces flameouts. A variable circulation time of liquid oxygen and related compounds down the duct hampers the calculation of the optimum amount of the compounds that will be used. It is desirable to have a device available which automatically controls the proper amount of liquid oxygen and related compounds given at any altitude.

### BRIEF SUMMARY OF THE INVENTION

It is an object of the present invention to provide a method and apparatus to automatically administer liquid oxygen from the oxidizer injector of a high altitude turbojet engine to the duct upstream of the compressor to increase thrust, altitude, and speed.

In carrying out the above objects and other stated objects and features of the present invention a method and apparatus is provided as a Stratojet for maintaining a desired O2 content in Vol % at the outlet of a high altitude turbojet, and includes delivering a first liquid oxygen dose—herein called an oxidant dose—to the duct upstream of the compressor, as described in '463, producing a sequential oxygen content dose at the outlet selected from one of a plurality of sequential oxygen content doses between a first oxygen content dose and a second oxygen content dose. The method includes delivering a second oxidant dosage to the duct while repeatedly sequencing through the plurality of sequential oxygen content doses to the outlet beginning with the first oxygen content dose and proceeding to an adjacent oxygen content dose in the sequence after a predetermined time interval has elapsed. The second oxidant dosage is delivered to the duct until the oxygen content level at the outlet attains the desirable range, at which point corresponding oxidant doses and oxygen content doses are selected from the plurality of oxidant doses and the plurality of sequential oxygen content doses. The method also includes delivering the selected oxidant dose to the duct and oxygen content dose to the outlet so as to maintain the desired oxygen content range at the outlet.

In the preferred embodiment the method and apparatus employs liquid oxygen as the sole oxidant. The other known oxidants may be employed as well.

The advantages of the Stratojet are its ability to fly higher and faster with less flameouts due to proper oxygenation of the turbojet engine.

The above objects, features, and other advantages will be readily appreciated by one of ordinary skill in the art from the following detailed description of the best mode in carrying out the invention, when taken in connection with the accompanying drawings.

### BRIEF DESCRIPTION OF THE DRAWINGS

FIG. 1/6 demonstrates a perspective view of the first embodiment of the present invention.

FIG. 2/6 is a graphical demonstration of the flow charts of the Stratojet.

FIG. 3/3-5/6 are flow charts dealing with the oxidant dosage and oxygen content dosage and level (labeled O2 in the flow sheets) strategy of the present invention for use in the Stratojet.

FIG. 6/6 is a flow chart for relating parameters in the Stratojet.

### DETAILED DESCRIPTION OF THE INVENTION

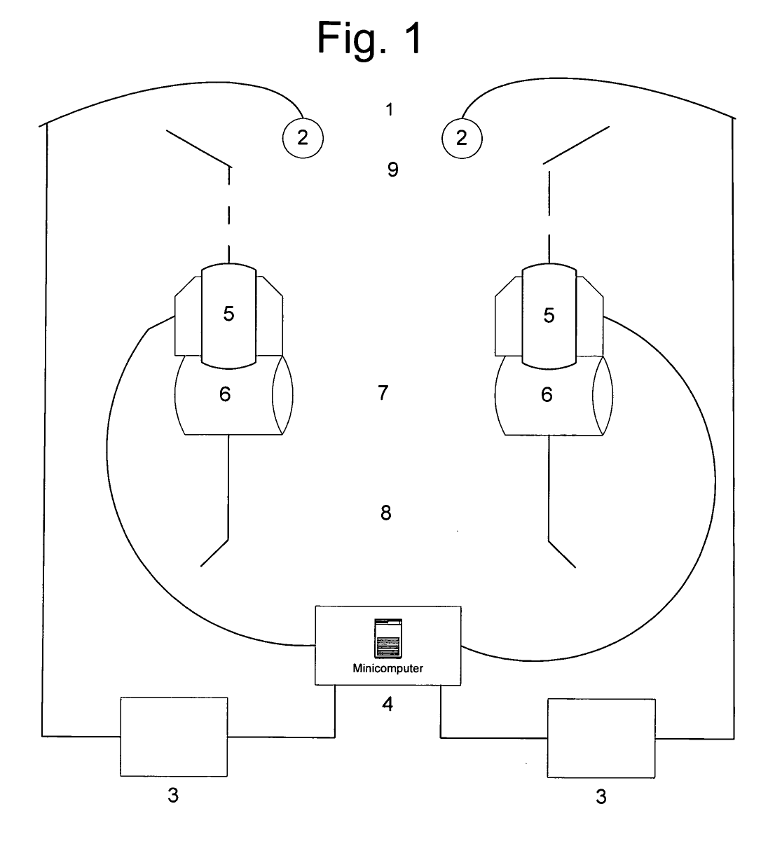

Referring now to FIG. 1/6, a first embodiment of the present invention is shown. This embodiment indicated by reference number 1 in FIG. 1/6 is the best mode in implementing this invention and is particularly suited for use as a Stratojet, and includes 2. an oxygen content sensor, 3. a bandpass filter, 4. the ECU, 5. variably opening solenoid valves, 7. the duct, 8. the inlet, 9. the outlet. The rest of the engine is described in '463.

In response to oxygen content data 2 at the outlet, oxidant flow rates at the oxidizer injector 6 are controlled by an ECU 4 controlled variably opening solenoid valve 5 with Coulomb controlling circuits, as was taught in 877 and U.S. Pat. No. 5,008,773. They enhance or restrict engine performance as taught in '463.

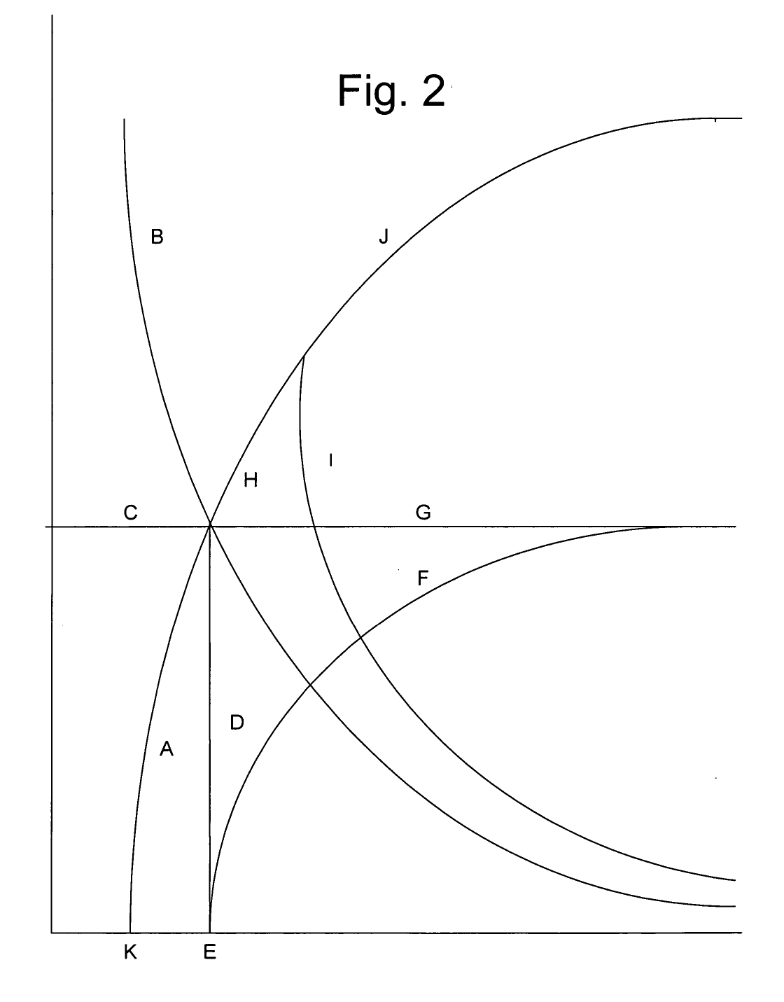

Referring now to FIG. 2/6, the method of device function is demonstrated graphically. Oxygen content is placed on the ordinate and time or oxidant dose are placed on the abscissa of a Cartesian plane. Maximum oxidant dosage occurs at tr on the abscissa, the significance of which will be presented later. Measured and calculated logarithmic functions are used in the preferred embodiment as oxygen content dosages, but any measured and estimated function with an inverse may be used. .

Referring again to FIG. 1/6, as will be seen, conditions on the oxygen content level at the outlet—the preferred parameter—control oxidant flow rate 6 into the duct and thus oxygen content dosage and levels at the outlet.

Referring now to FIG. 2/6, the illustrated method of oxidant dosage and oxygen content dosage and level (how both can exist will be explained) selection starts with the administration at the duct upstream to the compressor of an extreme oxidant flow rate—herein referred to as the selector dose of the oxidant flow rate which produces the maximum or minimum oxygen content dosage—as in curve A or B. Curve A is represented by y=log to the base a of x. Curve A activates at x=0.

Line CG is the desired oxygen content level—herein referred to as the selection parameter, which is a range in the actual device. At the intersection of line CG and curve A or B (call it X), line D points to point E on the abscissa as the selected oxidant dose. This is determined by graphical means and, as will be seen, the flow charts. The virtual oxygen content dosage in Vol % is curve F, which activates at point E, the selected oxidant flow rate, and is boosted by curves A, B, H—an overshoot of curve A—and curve I—a deactivation of curve H—to produce line G, which is the selected oxygen content level, is also a dosage, and is represented by y=log to the base b of tr , where tr is the t value of the flattening out of the logarithm y=log to the base b of t (curve F) at tr seconds. Line G is completely determined by the intersection (X) described above and in the flow charts, as will be seen, thus the determination of curve F and line G by the above methods is unnecessary. Curve F and line G start in the x coordinate system at x=t and in the t coordinate system at t=0, when curve A deactivates. Curve F and line G deactivate when curve A activates. Curve J is the virtual curve of curves A and H. K marks the Circulation time. It marks the time from the initial oxidant flow rate to the first recording of any change in the oxygen content dosage or level. Its accuracy is essential for proper flow chart function with respect to time. Its calculation and that of tr will be demonstrated. The oxidant dose is circulation time dependent. The oxygen content dose is not, since it is a function of time.

Before describing the flow charts it is useful to explain the terminology employed. The most recent base state keeps the oxygen content in its desirable range. The oxidant flow rate and oxygen content level are measured in all states. The washout state washes out overshoots. It also determines the selected oxygen content dose and oxidant flow rate, as will be seen. Oxygen content doses are functions of oxidant flow rates.

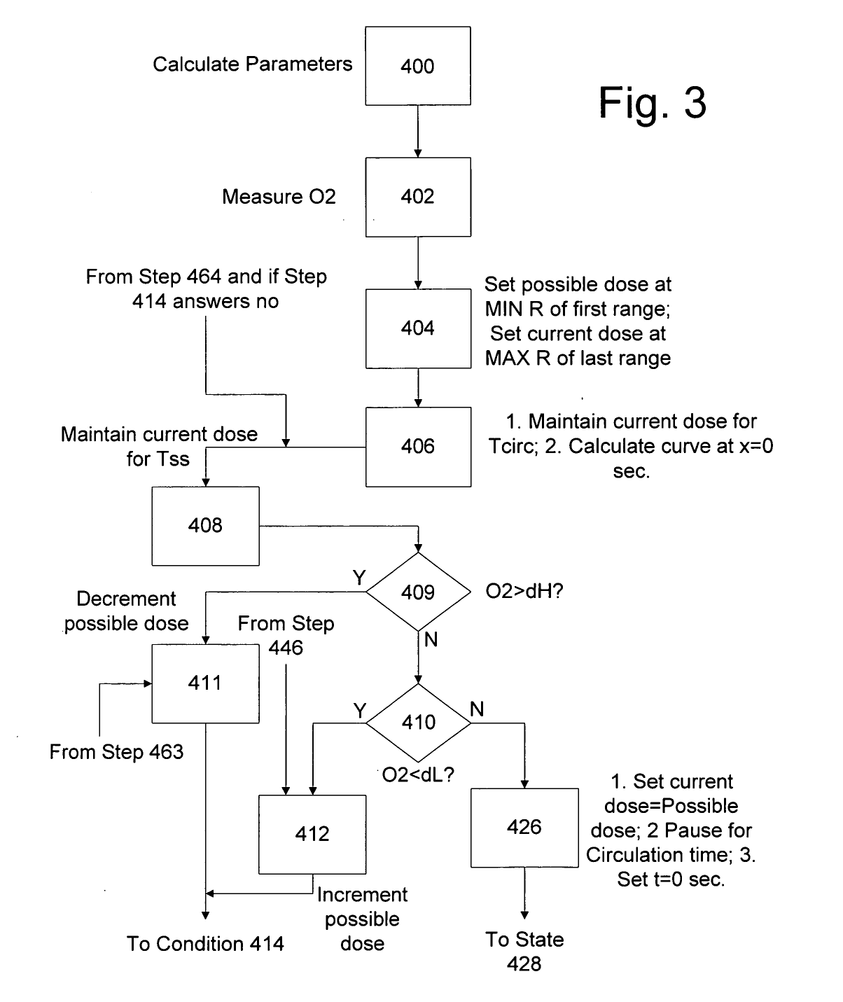

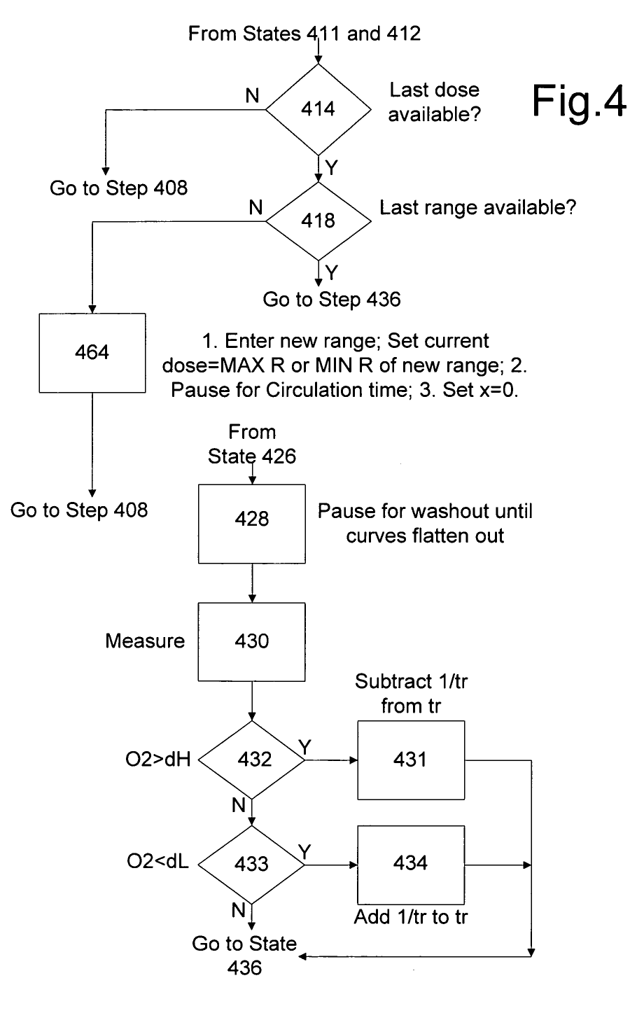

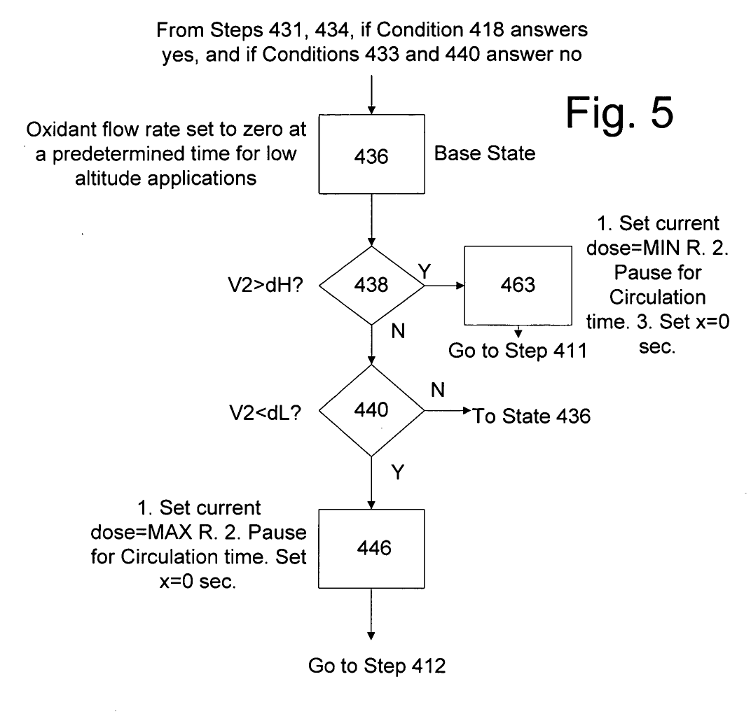

Referring now to FIG. 3/6-5/6, flow charts are shown, which illustrate the system and method for the proper selection of oxidant flow rates and oxygen content doses and levels.

Referring to FIG. 3/6, Step 400 determines various system parameters, which may be predetermined and stored in memory, calculated by an ECU (such as ECU 4 in FIG. 1/6) or entered by a system operator. The system parameters include the following:
MIN R=minimum dose of oxidant flow rate given for each range.
MAX R=maximum dose of oxidant flow rate given for each range.
O2=oxygen content level in Vol%
TO1=desired O2 level.
dL=low O2 level threshold.
dH=high O2 level threshold.
Tss=series state delay time.
Tcirc=circulation delay time.
Twash=washout delay time.
tr=desired response time or reaction time
   The value of dH and dL are O2 content levels determined by the current operating state, as will be seen, increasing with increasing altitude and consequential ambient air ratification.

As shown in FIG. 3/6 the ECU now passes control to Step 402, which measures the oxidant flow rate and O2 level. At Step 404 a maximum oxidant dose of the last range is administered. This is represented graphically by curve A of FIG. 2/6 and is called the selector dose. It represents the maximum oxidant dose. The possible O2 level is set for the lowest level of the lowest range.

With continuing reference to FIG. 3/6 at Step 406 the oxidant dose is maintained while pausing Tcirc seconds, then x is set to 0 seconds. Step 406 is called an adjustment state. It coordinates the flow charts with respect to time. Initial circulation times may be estimated or measured.

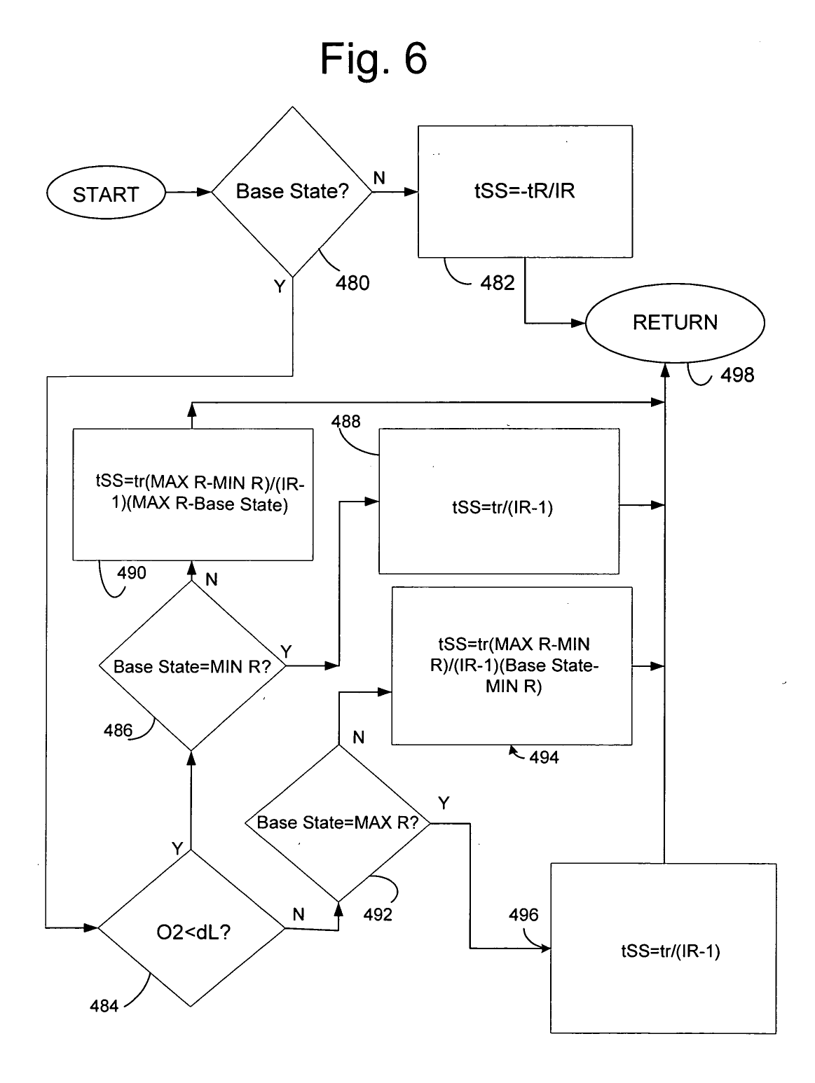

Referring once again to FIG. 3/6 the ECU passes control to Step 408, which continues to deliver maximum oxidant dosage to the duct. Step 408 is referred to as a series state—Tss—and is necessary to coordinate the progression through various possible O2 levels within a time period determined by tr. The calculation of Tss depends on the current operating state. Some representative calculations are illustrated in FIG. 6/6 for a single ranged implementation as discussed in greater detail below.

Still referring to FIG. 3/6 a test is performed at Steps 409 and 410. It asks—is O2 greater than dH?—and, is O2 less than dL?, respectively. They split control into three pathways. Negative answers to both conditions direct control to Step 426, where 1. The definitive current O2 level is set to the possible level, while the preliminary oxidant dose is set one circulation time into the future. 2. A pause for the circulation time takes place. Then, 3. t is set to 0. This represents preliminary oxidant dose and definitive oxygen content level or dose selection.

Now referring to FIG. 4/6 processing continues with the ECU directing control to Step 428, which pauses to washout high valued functions from the selected dose. The state is completed when all involved functions equal a straight line—the selected oxygen content level or dose. For convenience in the representation of the method in the flow charts the ECU was represented to set t=0 in Step 426. This actually occurs at the start of the washout state. The ECU directs in the washout state the determination of the selected value of point E of FIG. 1/6—the definitive selected oxidant dose—then activates this dose. The oxygen content dose remains the selected dose as line G in FIG. 1/6. Both of the above dosages continue until activation of MIN R or MAX R. FIG. 430 measures O2 values for the Conditions below. Steps 409 and 410 represent a second test and ask the same questions as the above mentioned first test—Is O2 greater than dH or less than dL, respectively? If either answer yes, control is directed to Steps 431 and 434, respectively, where a predetermined fraction of tr is either subtracted or added, respectively to tr. This pathway determines tr only if the circulation time is correct. The circulation time is calculated by keeping the last three base state values in memory. When control is directed to or beyond a noncontiguous base state from which control was originally assumed a predetermined amount of time is added to the circulation time. This will correct abnormally short circulation times. For abnormally long circulation times—if control passes consecutively to two ascending or descending base states, a predetermined amount of time is subtracted from the circulation time.

Referring now to FIG. 5/6, if both conditions in the second test answer no, the ECU places control in Step 436, the base state, where the oxidant flow rate may be manually or automatically at a predetermined time set to zero to accommodate low altitude flight. Steps 438 and 440 represent the third test and ask the same questions (is O2>dH or <dL?) as those of the previous tests with different consequences. They determine the stability of the base state (both conditions answer no if it is stable). If it is unstable, the ECU directs control to either Step 463, if Step 438 answers yes, or 446, which 1. Minimizes or maximizes the current dose, respectively 2. Pauses for the circulation time, then 3. Sets x=0. These doses continue until dose selection. It should be noted that Steps 431, 434, the yes part of 418, and the no part of Steps 433 and 440 all yield control to Step 436, the base state. The ECU then directs control from Step 463 to Step 411, and from Step 446 to Step 412.

Referring again to FIG. 3/6, the ECU directs control from Step 464 (evaluated later), and if Step 414 in FIG. 4/6 (the first condition of fourth test to be elucidated soon) answers no, to Step 408 to maintain the current O2 dose for Tss. Control is then directed to Step 409, which, if along with Step 410—the first test—the answer is yes to both conditions, control is passed to Steps 411 and 412, respectively, which decrement and increment the possible dose, respectively, then both pass control to Condition 414.

Referring now to FIG. 4/6, Steps 414 and 418 represent the fourth and final test with different conditions than the other tests. These conditions ask if the present possible dose is the last dose available, and if the present range is the last one available, respectively. If Step 414 answers no, control is directed by the ECU to Step 408 in FIG. 3/6, which maintains a current dose for Tss. If the condition answers yes, control is directed to Step 418, which determines if the present range is the last range available. If it answers no, control is directed to Step 464, in which control enters a new range, sets the current oxidant and O2 dose to MAX R or MIN R of the new range, pauses for the circulation time, then sets x=0. Control is then directed to Step 408, which maintains a current oxidant and O2 dose for Tss. If Step 418 answers yes, the ECU directs control to Step 436, the base state.

Referring now to FIG. 6/6 a flow chart is shown illustrating representative calculations of Tss according to the present invention. One of these calculations or an analogous calculation is performed for each series state of FIG. 3/6-5/6, such as illustrated at Steps 408, 411, and 412.

Returning to FIG. 6/6 at Step 480 a test is performed to determine if the system has reached a base state. If not, the series state delay is estimated as: Tss=tr/IR. If the result is true, the process continues with Step 484, where a test is performed to determine whether O2<dL. If true, then Step 486 determines whether the most recent base state is a minimum for the current range. If it is true, the series state delay is calculated by Step 488 as Tss=tr/(IR-1). Step 498 then returns control to the series state which initiated the calculation.

With continuing reference to FIG. 6/6, if the test at Step 486 is false, then the series state delay is calculated by Step 490 as Tss=tr(MAX R-MIN R)/(IR-1)(MAX R-BASE STATE) before control is released to the series state via Step 498. If the test performed at Step 484 is false, then Step 492 performs a test to determine if the most recent base state is the maximum for the current range. If the result of Step 492 is true, then Step 496 calculates the series state delay as Tss=tr/(IR-1). Control is then returned to the appropriate series state via Step 498. If the result of the test at Step 492 is false, then the series state delay is calculated by Step 494 as Tss=tr(MAX R-MIN R)/(IR-1)(BASE STATE-MIN R). Step 498 then returns control to the appropriate series state. FIG. 6/6 applies to a single range. One of ordinary skill in the art should appreciate that the calculations may be modified to accommodate a number of possible ranges.

It should be apparent to any one skilled in the art that the flow charts provide a method and apparatus for a Stratojet.

1. A method for maintaining a desired oxygen content level at the outlet of a high altitude turbojet within a predetermined range of sequential values having an upper limit and a lower limit so as to produce and deliver appropriate liquid oxidants to the duct upstream of the compressor to increase thrust, speed, and altitude and decrease flameouts, the method being adapted for use with a Stratojet, including an electronic control unit (ECU) having memory, a turbojet engine, an oxygen content sensor at the outlet, a liquid oxidant delivery system controlled by the ECU for delivering selected oxidant doses to the duct upstream of the compressor, producing oxygen content doses at the outlet, the oxygen delivery system of the Stratojet having a plurality of oxidant and oxygen content doses ranging from a first dose to a second dose, the method comprising:
delivering the second oxidant dose to the duct and the second oxygen content dose to the outlet, while repeatedly sequencing through the plurality of sequential oxygen content doses beginning with the first dose and proceeding to an adjacent dose in the sequence after a predetermined time interval has elapsed until the oxygen content level at the outlet of the Stratojet attains the desired level at which point a corresponding oxidant dosage in the duct upstream of the compressor and oxygen content dose at the outlet are selected from the plurality of sequential oxidant and oxygen content doses;
delivering the selected oxidant and oxygen content doses so as to maintain the outlet oxygen content level in its desired range.

2. The method of claim 1 wherein the current circulation time is determined by:
means for storing a predetermined number of base state values in memory; and
means for determining a predetermined sequence of base state levels.

3. The method of claim 1 wherein the reaction time is determined by logic flow charts.

4. The method of claim 1 wherein compressed gaseous air is the oxidant.

5. The method of claim 1 wherein compressed oxygen gas is the oxidant.

6. A method for maintaining a desired oxygen content at the outlet of a high altitude turbojet within a predetermined range of sequential values having an upper limit and a lower limit so as to produce and deliver appropriate liquid oxidants to the duct upstream of the compressor to increase thrust, speed, and altitude, and decrease flameouts, the method being adapted for use with a Stratojet, including an electronic control unit (ECU) having memory, a turbojet engine, an oxygen content sensor at the outlet, a liquid oxidant delivery system controlled by the ECU for delivering a selected oxidant dose to the duct upstream of the compressor producing oxygen content doses at the outlet, the oxidant delivery system having a plurality of sequential oxidant and oxygen content doses ranging from a first dose to a second dose, the method comprising:
delivering the second oxidant dose to the duct upstream of the compressor, while sequencing through the plurality of sequential oxidant doses beginning with the first oxidant dose and proceeding to an adjacent oxidant dose in the sequence after a predetermined time interval has elapsed until the oxygen content level of the Stratojet attains the desired level at which point a corresponding oxidant dosage is selected from the plurality of sequential oxidant doses.
delivering the selected oxidant dose to the duct upstream of the compressor so as to maintain the oxygen content level at the outlet of the turbojet in its desired range.

7. The method of claim 6 wherein the current circulation time is determined by:
means for storing a predetermined number of base state values in memory; and
means for determining a predetermined sequence of base state levels.

8. The method of claim 6 wherein the reaction time is determined by logic flow charts.

9. The method of claim 6 wherein the oxidant is compressed gaseous air.

10. The method of claim 6 wherein the oxidant is compressed oxygen gas.
